(19) United States
(12) Patent Application Publication
(10) Pub. No.: US 2026/0195229 A1
(43) Pub. Date: Jul. 9, 2026

(54) EVALUATION OF GENERATIVE AI THROUGH FORMULATION OF THEORY OF MIND

(71) Applicant: International Business Machines Corporation, Armonk, NY (US)

(72) Inventors: Aaron Keith BAUGHMAN, Cary, NC (US); Rahul AGARWAL, Jersey City, NJ (US); Gozde AKAY, Fredericton (CA); Smruthi RAJ MOHAN, Jersey City, NJ (US)

(21) Appl. No.: 19/015,245

(22) Filed: Jan. 9, 2025

(51) Int. Cl. G06F 11/34

(52) U.S. Cl. CPC G06F 11/3409

(57) ABSTRACT

The present disclosure provides a method for evaluating machine-generated articles using baselines guided by a theory of mind. The method includes generating a plurality of articles using a generative AI model, dividing the plurality of articles into two groups, comprising a first group comprising articles subjected to human editing to align with a quality standard, and a second group comprising articles that remain unedited, assigning scores to the plurality of articles across a set of quality dimensions, storing the scores in a first score matrix for the first group of articles, calculating covariance data for the first group using the first score matrix, constructing a polygon for each article in the first group within a multi-dimensional space, calculating an area of each polygon within the multi-dimensional space, and establishing a first baseline threshold based on the calculated areas for the articles in the first group.

### BACKGROUND

The present invention relates to generative artificial intelligence (GenAI), and more specifically, to evaluating and improving the quality of articles generated by GenAI models through the use of computational established baselines.

### SUMMARY

One embodiment presented in this disclosure provides a method, including generating a plurality of articles using a generative artificial intelligence (AI) model, dividing the plurality of articles into two groups, comprising a first group comprising articles subjected to human editing to align with a quality standard, and a second group comprising articles that remain unedited, assigning scores to the plurality of articles across a set of quality dimensions, storing the scores in a first score matrix for the first group of articles, calculating covariance data for the first group using the first score matrix, constructing a polygon for each article in the first group within a multi-dimensional space by combining the scores in the first score matrix with the corresponding covariance data, calculating an area of each polygon within the multi-dimensional space, where each polygon corresponds to an article in the first group, and establishing a first baseline threshold based on the calculated areas for the articles in the first group, where the first baseline threshold represents the quality standard predefined by human editors.

Other embodiments in this disclosure provide computer-readable media containing computer program code that, when executed by operation of a computer system, performs operations in accordance with one or more of the above methods, as well as systems comprising one or more memories collectively containing one or more programs, and one or more processors, where the one or more processors are configured to, individually or collectively, perform an operation in accordance with one or more of the above methods.

### BRIEF DESCRIPTION OF THE DRAWINGS

FIG. 1 depicts an example computing environment for the execution of at least some of the computer code involved in performing the inventive methods.

FIG. 2 depicts an example workflow for generating a first baseline threshold for human-edited articles, according to some embodiments of the present disclosure.

FIG. 3 depicts an example workflow for generating a second baseline threshold for machine-generated articles and determining a tolerance range, according to some embodiments of the present disclosure.

FIG. 4 depicts an example workflow for processing a new article to determine whether the article meets the expected human-editing standards, according to some embodiments of the present disclosure.

FIG. 5 depicts an example method for constructing a Theory of Mind for generative AI models by formulating baseline thresholds and a tolerance range, according to some embodiments of the present disclosure.

FIG. 6 depicts an example method for generating a first baseline threshold, according to some embodiments of the present disclosure.

FIG. 7 depicts an example method for generating a second baseline threshold, according to some embodiments of the present disclosure.

FIG. 8 depicts an example method for processing a new article and determining the article's quality alignment, according to some embodiments of the present disclosure.

FIG. 9 is a flow diagram depicting an example method for Theory-of-Mind formation for generative AI models, according to some embodiments of the present disclosure.

### DETAILED DESCRIPTION

Generative artificial intelligence (AI) (hereinafter referred to as generative AI, GenAI, or GAI) is a rapidly evolving technology capable of creating text, images, videos, and other data using generative models, often in response to specific prompts. The improvements in transformer-based deep neural networks, particularly large language models (LLMs), have made generative AI popular in many industries. A common approach to guiding LLM outputs involves techniques such as 1-shot or few-shot learning, where compliant examples are included within a prompt to shape the model's response. Another technique, in-context learning, provides relevant information or instructions directly within the prompt. For example, a user can include pre-written facts and instructions together in the input. These techniques help shape the model's response and make it useful in areas like writing, customer support, and design.

Despite the potential, generative AI models face challenges when tasked with producing long-form content spanning multiple paragraphs. Balancing the model's creativity with prescriptive control remains an unresolved problem. When models are given too much creative freedom through parameters like temperature, sampling rate, top-k, top-p, or beam width, the models often generate content with issues such as factual inaccuracies, nonsensical text, or internal contradictions. Conversely, overly restrictive approaches, such as rigid few-shot learning templates generated within synthesizers, can lead to dry and repetitive output. Striking a balance between control and creativity is not only technically complex but also time-consuming, as it involves aligning the model's output with the multifaceted expectations of human editors.

The present disclosure introduces a system and method that translate user expectations into an objective function, formulating a Theory of Mind, and implement these rules into the model's framework to control and guide the model's outputs. The disclosed method bridges the gap between LLMs' creativity and user-defined control, aligning generative AI model outputs with end-user expectations in a systematic and efficient manner. As used herein, the Theory of Mind refers to a framework that translates end-user's mental state, like beliefs, desires, and intentions into an objective function. This objective function may be represented by constructs like baselines or tolerance ranges, which provide measurable standards for evaluating the quality of AI-generated outputs. By integrating the Theory of Mind into the generative AI models, the disclosed system aligns the model's outputs within human expectations, reducing reliance on manual content review and editing, streamlining the evaluation process, and improving the efficiency of generating high-quality and publishable content.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

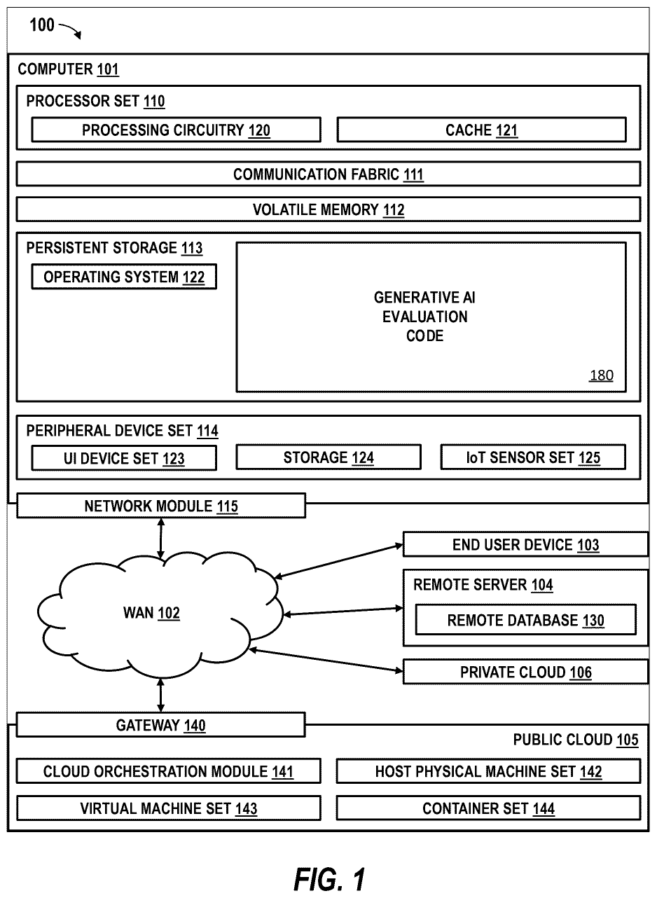

FIG. 1 depicts an example computing environment 100 for the execution of at least some of the computer code involved in performing the inventive methods.

Computing environment 100 contains an example of an environment for the execution of at least some of the computer code involved in performing the inventive methods, such as Generative AI Evaluation Code 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Generative AI Evaluation Code 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch, or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Generative AI Evaluation Code 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in Generative AI Evaluation Code 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private cloud 106 and public cloud 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

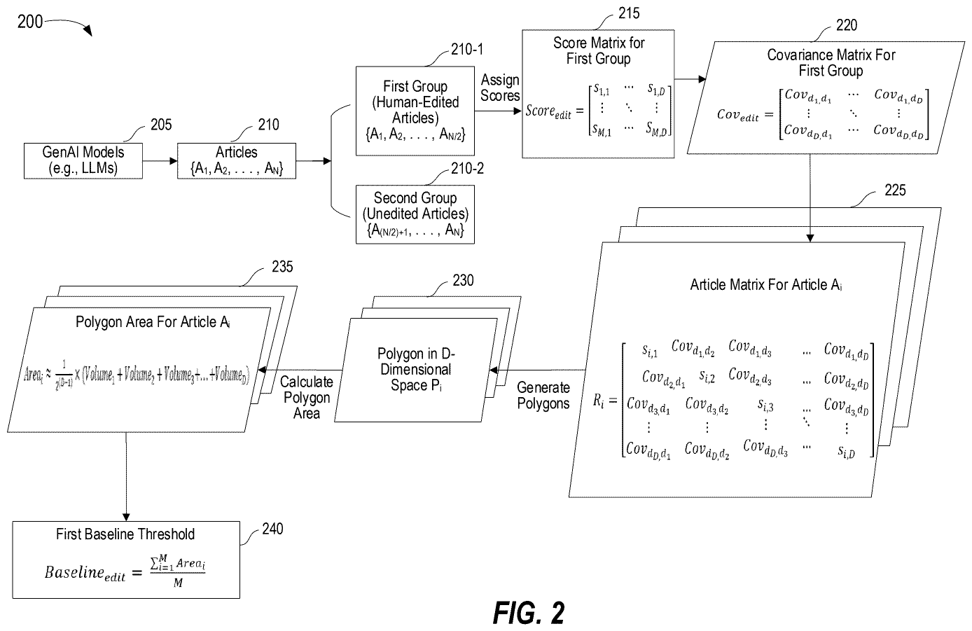

FIG. 2 depicts an example workflow 200 for generating a first baseline threshold for human-edited articles, according to some embodiments of the present disclosure.

As depicted, the workflow 200 begins with using the generative AI model 205 (e.g., LLM) to generate a set of N articles 210, represented mathematically as {A₁, A₂, A₃, . . . , A_{N}}. In some embodiments, the generative AI model 205 may be initialized with specific parameters, such as temperature (which controls the randomness of the output), top-k/top-p sampling (which restricts the model to consider only the most probable words or phrases), and beam width search (which expands the diversity of the generated response by exploring multiple options at each step). In some embodiments, to generate the set of articles 210, a designed prompt may be provided to the generative AI model 205. The prompt may specify a topic or theme, such as “write an article about effective time management strategies” and may include example outputs or instructions to demonstrate the tone, structure, and/or style expected from the model. Each of the generated articles 210 is a raw output from the generative AI system and may include multiple sentences or paragraphs.

Following the generation of the raw articles 210 (also referred to in some embodiments as machine-generated articles), the articles 210 are then divided equally into two groups for further processing and analysis. As depicted, the first group 210-1 includes N/2 articles, represented mathematically as {A₁, A₂, A₃, . . . , A_{N/2}}, and the second group 210-2 includes the remaining N/2 articles, represented mathematically as {A_{(n/2+1)}, A_{(n/2+2)}, A_{(n/2+3)}, . . . , A_{N}}. The articles in the first group 210-1 are then provided to human editors for refinement. The editors may review and edit the articles to align them with various editorial standards or preferences. In some embodiments, the standards may include various attributes, such as factual accuracy, coherence, novelty, relevancy, repetitiveness, and stylistic appropriateness. The editorial standards may be predefined (e.g., by a publisher) to maintain a high-quality benchmark that reflects human expectations. The articles in the second group 210-2 remain unchanged and preserve the raw outputs as generated by the AI model 205. This group 210-2 may serve as a baseline for understanding the generative AI models' inherent quality without any human intervention.

The division of articles into two equal groups is provided for conceptual clarity. In some embodiments, the proportions assigned to each group may vary depending on the specific use case and/or experimental requirements. For example, in some embodiments, two-thirds (⅔) of the articles are assigned to the first group 210-1 for human editing, while the remaining one-third (⅓) are left as the second group 210-2 of unedited articles.

As depicted, each article Aᵢ in the first group 210-1 is evaluated across a set of D quality dimensions. These dimensions capture various aspects of content quality and provide a structured way to assess the article's alignment with human editorial standards. The scores for these dimensions are saved in a score matrix 215, mathematically represented as follows:

$${Score}_{edit} ∈ {R}^{M \times D} ;$$

$${Score}_{edit} = [ \begin{matrix}{s}_{1 , 1} & … & {s}_{1 , D} \\ ⋮ & ⋱ & ⋮ \\ {s}_{M , 1} & … & {S}_{M , D}\end{matrix} ] ;$$

where M=N/2, representing the number of articles in the first group;
D represents the number of quality dimensions; and
s_{i,j} represents the score assigned to the i-th article for the j-th quality dimension.

In some embodiments, each article may be evaluated across four quality dimensions, each measured on a scale from 1 to 100. The four quality dimensions may include factuality, novelty, repetitiveness, and relevancy. As used herein, the factuality evaluates the factual correctness of the content relative to any provided context or corpus. A score closer to 100 indicates that the content is factually accurate and consistent with known information. As used herein, the novelty measures the extent to which the content introduces new and novel ideas or sentences when compared to the context or corpus. A higher score indicates greater novelty. As used herein, the repetitiveness evaluates the repetition of similar words or phrases in the content. Lower scores indicate fewer repetitions and better diversity in the generated text. In some embodiments, diversity may be used as a substitute for repetitiveness, where a higher score indicates better performance. As used herein, the relevancy measures how relevant the content is to the intended audience or topic. A higher score reflects content that closely matches audience expectations and context.

In some embodiments, the score may be assigned by human reviewers who evaluate the content against predefined guidelines for each dimension. In some embodiments, automated scoring models may analyze the article to assign scores based on natural language processing techniques. These approaches may be used independently or in combination to maintain consistency and accuracy in scoring across all articles.

For example, if the first group 210-1 has five articles (e.g., M=5), each article may be scored across the four quality dimensions: factuality, novelty, repetitiveness, and relevancy. Since these articles have been human-edited, the scores represent the alignment of each article with human editorial standards and fall within the range of quality that reflects human expectations across these dimensions. The first article has a score of 85 for factuality, 75 for novelty, 60 for repetitiveness, and 90 for relevancy. The second article has a score of 90 for factuality, 80 for novelty, 65 for repetitiveness, and 88 for relevancy. The third article has a score of 78 for factuality, 85 for novelty, 70 for repetitiveness, and 85 for relevancy. The fourth article has a score of 92 for factuality, 70 for novelty, 58 for repetitiveness, and 92 for relevancy. The fifth article has a score of 88 for factuality, 78 for novelty, 62 for repetitiveness, and 89 for relevancy. The score matrix for the first group may be represented as follows:

$${Score}_{edit} = [ \begin{matrix}85 & 75 & 60 & 90 \\ 90 & 80 & 65 & 88 \\ 78 & 85 & 70 & 85 \\ 92 & 70 & 58 & 92 \\ 88 & 78 & 62 & 89\end{matrix} ] ;$$

As shown, each row corresponds to an article, and each column represents one of the four quality dimensions.

Following the score assignment, the system proceeds to analyze the relationship between the quality dimensions by calculating a covariance matrix for the first group. As used herein, the covariance matrix captures how the scores for different dimensions vary relative to each other across the first group of articles 210-1. The covariance matrix for the first group may be represented as follows:

$${Cov}_{edit} ∈ {ℝ}^{D \times D} ;$$

$${Cov}_{edit} = [ \begin{matrix}{Cov}_{{d}_{1 ,} {d}_{1}} & … & {Cov}_{{d}_{1 ,} {d}_{D}} \\ ⋮ & ⋱ & ⋮ \\ {Cov}_{{d}_{D ,} {d}_{1}} & … & {Cov}_{{d}_{D ,} {d}_{D}}\end{matrix} ] ;$$

where D represents the number of quality dimensions; and
Cov(dₖ, dₗ) represents the covariance between dimension k and dimension l.

The covariance between two dimensions k and l may be calculated using the following equation:

$$Cov ( {d}_{k} , {d}_{l} ) = \frac{1}{M - 1} {\sum }_{i = 1}^{M} ( {s}_{i , k} - \overline{{s}_{k}} ) ( {s}_{i , l} - \overline{{s}_{l}} ) ;$$

where M=N/2, representing the number of articles in the first group;
s_{i,k} represents the score of the i-th article for the k-th dimension;
s_{i,l} represents the score of the i-th article for the 1-th dimension;
s̅ₖ̅ represents the mean score of the k-th dimension across all articles in the first group; and
s̅ₗ̅ represents the mean score of the 1-th dimension across all articles in the first group.

In some embodiments, the s̅ₖ̅ may be calculated using the following equation:

$$\overline{{s}_{k}} = \frac{1}{M} {\sum }_{i = 1}^{M} {s}_{i , k}$$

The diagonal element Cov(dₖ, dₖ) represents the variance of a single dimension, while the off-diagonal element Cov(dₖ, dₗ) represents how dimensions vary together. In the above example, where the first group includes five articles, each evaluated across four quality dimensions (factuality, novelty, repetitiveness, and relevancy), the covariance matrix is as follows:

$${Cov}_{edit} = [ \begin{matrix}29.8 & - 22.95 & - 19.25 & 11.4 \\ - 22.95 & 31.3 & 25.5 & - 14.35 \\ - 19.25 & 25.5 & 22 & - 1285 \\ 11.4 & - 14.35 & - 12 & 6.7\end{matrix} ]$$

With the scores assigned and covariance data calculated, the system proceeds to transform each article Aᵢ in the first group to a multi-dimensional metric space. As depicted, each article is represented using an article matrix Ri 225, which combines the article's scores (diagonal elements) and the group-level covariance relationships (off-diagonal elements). The article matrix Ri for i-th article may be represented as follows:

$${R}_{i} = [ \begin{matrix}{s}_{i , 1} & {Cov}_{{d}_{1 ,} {d}_{2}} & {Cov}_{{d}_{1 ,} {d}_{3}} & … & {Cov}_{{d}_{1 ,} {d}_{D}} \\ {Cov}_{{d}_{2 ,} {d}_{1}} & {s}_{i , 2} & {Cov}_{{d}_{1 ,} {d}_{3}} & … & {Cov}_{{d}_{2 ,} {d}_{D}} \\ {Cov}_{{d}_{3 ,} {d}_{1}} & {Cov}_{{d}_{3 ,} {d}_{2}} & {s}_{i , 3} & … & {Cov}_{{d}_{3 ,} {d}_{D}} \\ ⋮ & ⋮ & ⋮ & ⋱ & ⋮ \\ {Cov}_{{d}_{D ,} {d}_{1}} & {Cov}_{{d}_{D ,} {d}_{2}} & {Cov}_{{d}_{D ,} {d}_{3}} & … & {s}_{i , D}\end{matrix} ] ;$$

where s_{i,k} represents the score for the k-th quality dimension of the i-th article; and
Cov(dₖ, dₗ) represents the covariance between quality dimensions k and l across the group.

In the above example, where the first group includes five articles, each evaluated across four quality dimensions (factuality, novelty, repetitiveness, and relevancy), the article matrix 225 for the first article (A₁) may be expressed as follows:

$${R}_{1} = [ \begin{matrix}85 & - 22.95 & - 19.25 & 11.4 \\ - 22.95 & 75 & 25.5 & - 14.35 \\ - 19.25 & 25.5 & 60 & - 1285 \\ 11.4 & - 14.35 & - 12 & 90\end{matrix} ] ;$$

Using the article matrix Ri 225, the system constructs a polygon 230 for each article in a multi-dimensional space. The polygon provides a geometric representation of the article's quality profile, with each vertex corresponding to a score or a covariance value (e.g., representing an inter-dimensional relationship). As depicted, the polygon 230 exists in a D-dimensional space, where D is the number of quality dimensions.

To calculate the polygon area 235 in a D-dimensional space, the Hausdorff dimension method may be used. This method facilitates area calculation in the original D-dimensional space by recursively projecting the polygon into lower-dimensional spaces. The equation to calculate the area in D-dimensional space is as follows:

$${Area}_{i} \approx \frac{1}{{2}^{( D - 1 )}} \times ( {Volume}_{1} + {Volume}_{2} + {Volume}_{3} + … + {Volume}_{D} ) ;$$

where D represents the number of dimensions in the space; and
Volumeᵢ represents the volume of the i-th face of the polygon in the (D-1) dimension.

Given the fact that the volume of a face in D-dimensional space is proportional to the area of that face in a (D-1)-dimensional space. The calculation may be simplified as follows:

$${Area}_{i} \approx \frac{1}{{2}^{( D - 1 )}} \times ( {Area}_{f a c e 1} + {Area}_{f a c e 2} + {Area}_{f a c e 3} + … + {Area}_{f a c e D} ) ;$$

where Area_{facei} represents the area of the i-th face of the polygon in the (D-1)-dimensional space.

In the above example, where the five articles in the first group are evaluated across four quality dimensions (factuality, novelty, repetitiveness, relevance), the polygon 230 is constructed in 4D space. To calculate the polygon area 235 in 4D space, the polygon may first be projected into 3D space. The system may then decompose the 3D polygon into triangular faces and compute their areas. Once face areas are determined, the 4D polygon area may be estimated using:

$${Area}_{4 D , i} \approx \frac{1}{{2}^{( 4 - 1 )}} \times ( {Area}_{f a c e 1} + {Area}_{f a c e 2} + {area}_{f a c e 3} + {Area}_{f a c e 4} )$$

After the polygon areas 235 for each article in the first group are determined, the system uses these calculated areas 235 to construct an expectation quality profile in D-dimensional space. This expectation quality profile reflects the overall quality standards extracted from the human-edited articles and serves as a baseline for evaluating future generative AI outputs. The expectation quality profile includes a first baseline threshold (also referred to as in some embodiments as human-editing baseline threshold), which is calculated as the mean polygon area for the articles in the first group. The first baseline threshold may be calculated as follows:

$${Baseline}_{edit} = \frac{{\sum }_{i = 1}^{M} {Area}_{i}}{M} ;$$

where M=N/2, representing the number of articles in the first group; and
Areaᵢ represents the polygon area of the i-th article in the D-dimensional space.

In some embodiments, the first baseline threshold may not be calculated as the simple mean of all polygon areas 235 in the first group. Instead, certain articles in the first group may be assigned more weight based on their importance or relevance to the editorial standards. For example, articles that more closely align with the desired quality dimensions may carry greater significance in determining the baseline. In such configurations, the first baseline threshold may be calculated as a weighted average of the polygon areas as follows:

$${Baseline}_{edit} = \frac{{\sum }_{i = 1}^{M} {w}_{i} {Area}_{i}}{{\sum }_{i = 1}^{M} {w}_{i}} ;$$

where wᵢ represents the weight assigned to the i-th article.

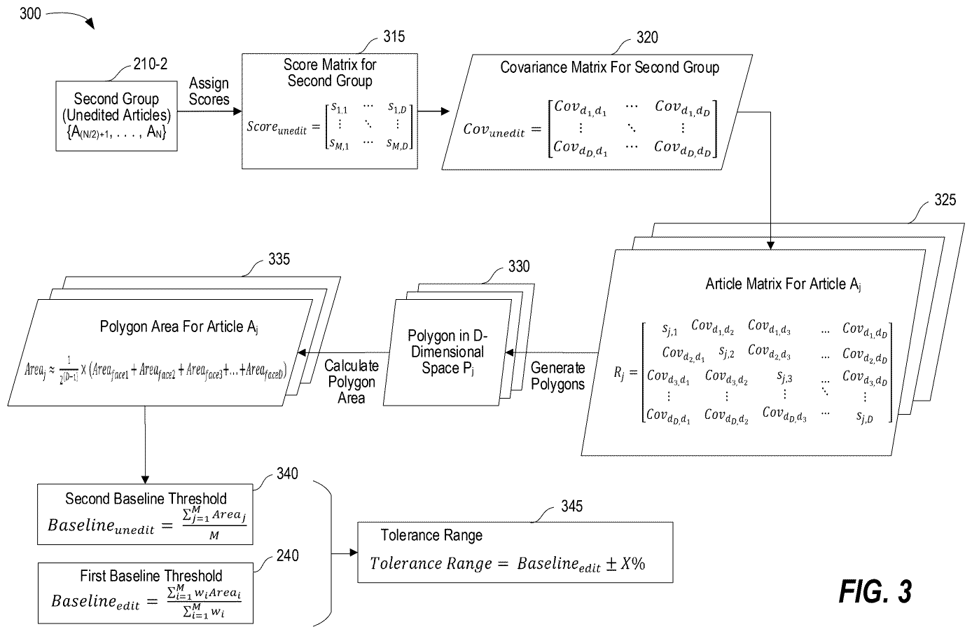

FIG. 3 depicts an example workflow 300 for generating a second baseline threshold for machine-generated articles and determining a tolerance range, according to some embodiments of the present disclosure.

As discussed in FIG. 2, the second group 210-2 includes N/2 articles, represented mathematically as {A_{(n/2+1)}, A₂, A₃, . . . , A_{N}}. Each article is unedited and raw AI-generated outputs.

As depicted in FIG. 2, each article in the second group 210-2 is scored across a set of quality dimensions (e.g., D quality dimensions), either through manual reviewing by human evaluators or through automated scoring using machine learning algorithms. Examples of dimension includes factuality, novelty, repetitiveness, and relevancy. The scores for these dimensions quantify the quality of each article based on predefined human editorial standards. The scores for these dimensions are saved in a score matrix 315, represented as follows:

$${Score}_{unedit} ∈ {R}^{M \times D} ;$$

$${Score}_{unedit} = [ \begin{matrix}{s}_{1 , 1} & … & {s}_{1 , D} \\ ⋮ & ⋱ & ⋮ \\ {s}_{M , 1} & … & {s}_{M , D}\end{matrix} ] ;$$

where M=N/2, representing the number of articles in the first group;
D represents the number of quality dimensions; and
s_{i,j} represents the score assigned to the i-th article for the j-th quality dimension.

In some embodiments, each article may be evaluated across four quality dimensions, each measured on a scale from 1 to 100. The four quality dimensions may include factuality, novelty, repetitiveness, and relevancy. For example, if the second group 210-2 includes five unedited articles, the score matrix for the second group may be represented as follows:

$${Score}_{unedit} = [ \begin{matrix}{s}_{1 , 1} & … & {s}_{1 , 4} \\ ⋮ & ⋱ & ⋮ \\ {s}_{5 , 1} & … & {s}_{5 , D}\end{matrix} ]$$

Using the score matrix 315, the system computes the covariance relationships between dimensions to create the covariance matrix 320, mathematically represented as follows:

$${Cov}_{unedit} ∈ {ℝ}^{D \times D} ;$$

$${Cov}_{unedit} = [ \begin{matrix}{Cov}_{{d}_{1 ,} {d}_{1}} & … & {Cov}_{{d}_{1 ,} {d}_{D}} \\ ⋮ & ⋱ & ⋮ \\ {Cov}_{{d}_{D ,} {d}_{1}} & … & {Cov}_{{d}_{D ,} {d}_{D}}\end{matrix} ] ;$$

where D represents the number of quality dimensions; and
Cov(dₖ, dₗ) represents the covariance between dimension k and dimension l.

As discussed above, the covariance between two dimensions k and l may be calculated using the following equation:

$$Cov ( {d}_{k} , {d}_{l} ) = \frac{1}{M - 1} {\sum }_{i = 1}^{M} ( {s}_{i , k} - \overline{{s}_{k}} ) ( {s}_{i , l} - \overline{{s}_{l}} ) ;$$

where M=N/2, representing the number of articles in the second group;
s_{i,k} represents the score of the i-th article for the k-th dimension;
s_{i,l} represents the score of the i-th article for the 1-th dimension;
s̅ₖ̅ represents the mean score of the k-th dimension across all articles in the second group; and
s̅ₗ̅ represents the mean score of the 1-th dimension across all articles in the second group.

In some embodiments, the s̅ₖ̅ may be calculated using the following equation:

$$\overline{{s}_{k}} = \frac{1}{M} {\sum }_{i = 1}^{M} {s}_{i , k}$$

For each article in the second group Aⱼ, the system constructs an article matrix Rⱼ 325 by combining the individual scores (diagonal elements) with the covariance data (off-diagonal elements). The article matrix 325 is expressed as follows:

$${R}_{j} = [ \begin{matrix}{s}_{j , 1} & {Cov}_{{d}_{1 ,} {d}_{2}} & {Cov}_{{d}_{1 ,} {d}_{3}} & … & {Cov}_{{d}_{1 ,} {d}_{D}} \\ {Cov}_{{d}_{2 ,} {d}_{1}} & {s}_{j , 2} & {Cov}_{{d}_{2 ,} {d}_{3}} & … & {Cov}_{{d}_{2 ,} {d}_{D}} \\ {Cov}_{{d}_{3 ,} {d}_{1}} & {Cov}_{{d}_{3 ,} {d}_{2}} & {s}_{j , 3} & … & {Cov}_{{d}_{3 ,} {d}_{D}} \\ ⋮ & ⋮ & ⋮ & ⋱ & ⋮ \\ {Cov}_{{d}_{D ,} {d}_{1}} & {Cov}_{{d}_{D ,} {d}_{2}} & {Cov}_{{d}_{D ,} {d}_{3}} & … & {s}_{j , D}\end{matrix} \text{} ]$$

where s_{j,k} represents the score for the k-th quality dimension of the j-th article; and
Cov(dₖ, dₗ) represents the covariance between quality dimensions k and l across the second group.

In the above example, where the second group includes five articles, each evaluated across four quality dimensions (factuality, novelty, repetitiveness, and relevancy), the article matrix 325 for the article (Aⱼ) may be expressed as follows:

$${R}_{j} = [ \text{} \begin{matrix}{s}_{j , 1} & {Cov}_{{d}_{1 ,} {d}_{2}} & {Cov}_{{d}_{1 ,} {d}_{3}} & {Cov}_{{d}_{1 ,} {d}_{4}} \\ {Cov}_{{d}_{2 ,} {d}_{1}} & {s}_{j , 2} & {Cov}_{{d}_{2 ,} {d}_{3}} & {Cov}_{{d}_{2 ,} {d}_{4}} \\ {Cov}_{{d}_{3 ,} {d}_{1}} & {Cov}_{{d}_{3 ,} {d}_{2}} & {s}_{j , 3} & {Cov}_{{d}_{3 ,} {d}_{4}} \\ {Cov}_{{d}_{4 ,} {d}_{1}} & {Cov}_{{d}_{4 ,} {d}_{2}} & {Cov}_{{d}_{4 ,} {d}_{3}} & {s}_{j , 4}\end{matrix} \text{} ]$$

Using each article matrix 325, a polygon 330 is constructed in D-dimensional space, where D is the number of quality dimensions. In the above example where each article is evaluated across four quality dimensions, D is equal to 4, and the polygon 330 is constructed in 4D space.

Following the polygon construction, the system proceeds to calculate the area of each polygon in the D-dimensional space using the Hausdorff dimension. As discussed above, the Hausdorff dimension method recursively projects the polygon into lower-dimensional spaces for simplification, represented as follows:

$${Area}_{j} \approx \frac{1}{{2}^{( D - 1 )}} \times ( {Area}_{face 1} + {Area}_{face 2} + {Area}_{face 3} + … + {Area}_{faceD} ) ;$$

where D represents the number of dimensions in the space; and
Area_{facei} represents the area of the i-th face of the polygon in the (D-1)-dimensional space.

In the above example, where the five articles in the second group are evaluated across four quality dimensions (factuality, novelty, repetitiveness, relevance), the polygon area 335 in 4D space is computed by first projecting into 3D space and calculating triangular face areas, represented as follows:

$${Area}_{4 D , j} \approx \frac{1}{{2}^{( 4 - 1 )}} \times ( {Area}_{face 1} + {Area}_{face 2} + {area}_{face 3} + {Area}_{face 4} )$$

Following the completion of polygon area calculation, the system proceeds to define the second baseline threshold 340 (also referred to in some embodiments as the AI baseline threshold) using the calculated polygon areas for the articles in the second group. In some embodiments, the second baseline threshold 340 may be calculated by averaging the polygon areas for the second group as follows:

$${Baseline}_{unedit} = \frac{{\sum }_{j = 1}^{M} {Area}_{j}}{M} ;$$

where M=N/2, representing the number of articles in the second group; and
Areaᵢ represents the polygon area of the i-th article in the D-dimensional space.

The second baseline threshold 340 reflects the inherent quality of the unedited, AI-generated articles and may be included within an AI-generated profile to quantify the performance of the generative AI model.

In some embodiments, certain articles in the second group may be assigned more weight than others based on their importance and/or relevance to the editorial standard. In this configuration, the second baseline threshold may be calculated as a weighted average of the polygon areas as follows:

$${Baseline}_{unedit} = \frac{{\sum }_{j = 1}^{M} {Area}_{j}}{{\sum }_{j = 1}^{M} {w}_{j}}$$

With both the first baseline threshold 240 (generated for human-edited articles) and the second baseline threshold 340 (generated for unedited articles) determined, the system compares the two baselines to analyze the difference between human expectations and AI-generated quality. Based on this comparison and other relevant factors (e.g., application requirements or stakeholder preferences), the system defines the tolerance range 345, which represents the allowable deviation from the first baseline threshold. The tolerance range may be represented as follows:

$$Tolerance Range = {Baseline}_{edit} \pm X \% ;$$

where the Baseline_{edit} represents the first baseline threshold;
and the X % represents the allowable deviation.

In some embodiments, the tolerance range 345 may then be used to evaluate new articles by comparing the new article's polygon areas against this range to determine whether these article meet the quality standards. Articles that fall within the tolerance range are considered to pass, while those outside the range may be flagged for further review or editing. Additionally, the number of passing or failing articles may be recorded, and when the number of failing articles exceeds a predefined threshold, it may trigger model retraining. During the retraining process, the difference between the first and second baseline thresholds (which represents the gap between human-edited quality standards and the inherent quality of unedited AI-generated articles) may be used to guide adjustments to the generative AI model. These adjustments may include refining the model's internal parameters, such as tuning generation settings (e.g., temperature, top-k, top-p) or modifying the model's loss functions, to adapt the model's output better align with human editorial expectations.

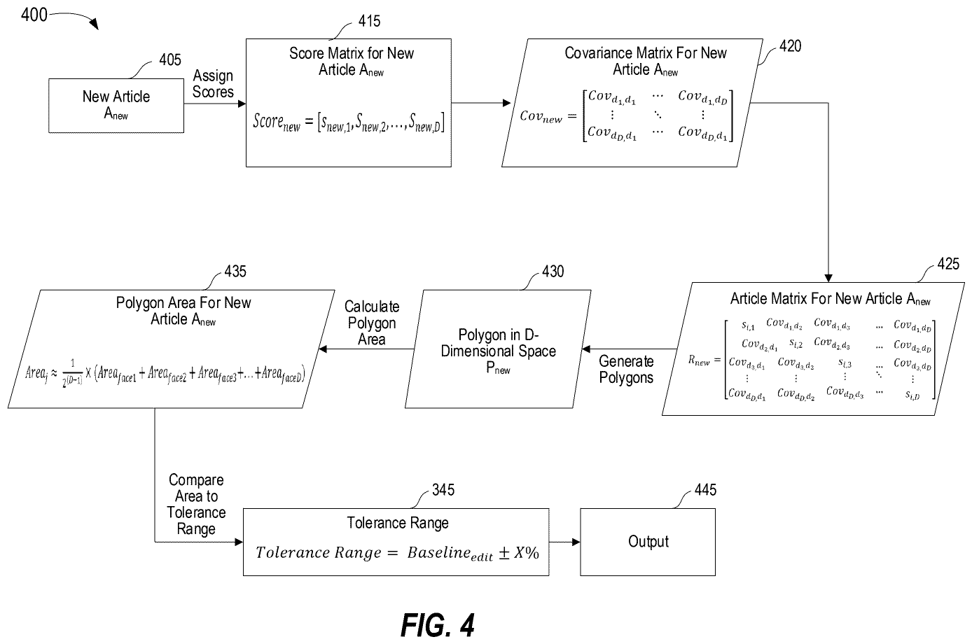

FIG. 4 depicts an example workflow 400 for processing a new article to determine whether the article meets the expected human-editing standards, according to some embodiments of the present disclosure.

As depicted, a new article 405 is generated by the generative AI model (e.g., LLM) in response to a prompt. The new article is evaluated across D quality dimensions (e.g., factuality, novelty, repetitiveness, and relevancy). In some embodiments, each quality dimension may be measured on a scale from 1 to 100. The scores are recorded in a score matrix 415 for the new article, represented as follows:

$${Score}_{new} = [ {s}_{new , 1} , {s}_{new , 2} , … , {s}_{new , D} ] ;$$

where D represents the number of quality dimensions; and
s_{new,j} represents the score assigned to the new article for the j-th quality dimension.

For example, if the new article is evaluated across four dimensions and receives a score of 85 for factuality, 80 for novelty, 70 for repetitiveness, and 90 for relevancy. The score matrix for the new article is as follows:

$${Score}_{new} = [ 85 , 80 , 70 , 90 ]$$

With the score matrix 415, the system calculates the covariance data 420 for the new article. The covariance data 420 captures the interrelationships between the quality dimensions for the new article. In some embodiments, instead of calculating covariance values directly for the new article (which requires multiple data points for the same article), the system may use the covariance matrix determined from the first group (e.g., 220 of FIG. 2).

Using the assigned scores 415 and the determined covariance matrix 420, the system transform the new article into a D-dimensional metric space. This transformation is represented as a multi-dimensional article matrix R_{new} 425, where the diagonal elements represent the scores assigned to the new article for each quality dimension, and the off-diagonal elements represent the covariance data from the baseline covariance matrix.

The article matrix R_{new} for the new article Anew is represented as follows:

$${R}_{new} = [ \begin{matrix}{s}_{1} & {Cov}_{{d}_{1 ,} {d}_{2}} & {Cov}_{{d}_{1 ,} {d}_{3}} & … & {Cov}_{{d}_{1 ,} {d}_{D}} \\ {Cov}_{{d}_{2 ,} {d}_{1}} & {s}_{2} & {Cov}_{{d}_{2 ,} {d}_{3}} & … & {Cov}_{{d}_{2 ,} {d}_{D}} \\ {Cov}_{{d}_{3 ,} {d}_{1}} & {Cov}_{{d}_{3 ,} {d}_{2}} & {s}_{3} & … & {Cov}_{{d}_{3 ,} {d}_{D}} \\ ⋮ & ⋮ & ⋮ & ⋱ & ⋮ \\ {Cov}_{{d}_{D ,} {d}_{1}} & {Cov}_{{d}_{D ,} {d}_{2}} & {Cov}_{{d}_{D ,} {d}_{3}} & … & {s}_{D}\end{matrix} \text{} ]$$

where sₖ is the score assigned to the new article for the k-th quality dimension; and
Cov(dₖ,dₗ) is the covariance between dimensions k and l, determined from the baseline covariance matrix (Cov_{edit}).

In the above example, where the new article is evaluated from four dimensions with scores of 85, 80, 70 and 90, the article matrix R_{new} is constructed as follows:

$${R}_{new} = [ \text{} \begin{matrix}85 & {Cov}_{{d}_{1 ,} {d}_{2}} & {Cov}_{{d}_{1 ,} {d}_{3}} & {Cov}_{{d}_{1 ,} {d}_{4}} \\ {Cov}_{{d}_{2 ,} {d}_{1}} & 80 & {Cov}_{{d}_{2 ,} {d}_{3}} & {Cov}_{{d}_{2 ,} {d}_{4}} \\ {Cov}_{{d}_{3 ,} {d}_{1}} & {Cov}_{{d}_{3 ,} {d}_{2}} & 70 & {Cov}_{{d}_{3 ,} {d}_{4}} \\ {Cov}_{{d}_{4 ,} {d}_{1}} & {Cov}_{{d}_{4 ,} {d}_{2}} & {Cov}_{{d}_{4 ,} {d}_{3}} & 90\end{matrix} \text{} ]$$

Using the article matrix 425, the system proceeds to construct a polygon 430 in D-dimensional metric space, where D is the number of quality dimensions (e.g., 4 for factuality, novelty, repetitiveness, and relevancy). Each vertex of the polygon corresponds to a score or covariance value, representing the article's quality profile geometrically.

The polygon area 435 is then calculated using the Hausdorff dimension method, which projects the polygon reclusively into lower dimension to simplify computation. For a polygon in 4D space, the area is estimated by summing the polygon area in 3D space, using the following equation:

$${Area}_{new} \approx \frac{1}{{2}^{( D - 1 )}} \times ( {Area}_{face 1} + {Area}_{face 2} + {Area}_{face 3} + … + {Area}_{faceD} ) ;$$

where D represents the number of dimensions in the space; and
Area_{facei} represents the area of the i-th face of the polygon in the (D-1)-dimensional space.

After the polygon area (Area_{new}) 435 for the new article is calculated, it is compared against the defined tolerance range 345 to determine whether the article falls within the allowable deviations from the first baseline threshold (Baseline_{edit}). As mentioned above, the tolerance range is defined as:

$$Tolerance Range = {Baseline}_{edit} \pm X \% ;$$

where X % represents the allowable deviation from the first baseline threshold (Baseline_{edit}).

If the Area_{new} 435 falls within the tolerance range 345, the article 405 is considered to meet the quality standards aligned with human expectations. If the Area_{new} 435 falls outside the tolerance range 345, the new article 405 is flagged for further review or editing.

Based on the comparison, the system outputs a decision 445, indicating whether the new article fails or passes the evaluation. The structured evaluation ensures that generative AI outputs are consistent with predefined quality expectations while minimizing (at least reducing) human efforts for content review. Additionally, in some embodiments, the system may monitor the number of articles failing the evaluation. If the number of failed articles exceeds a predefined threshold, the system triggers retraining of the GenAI model. During the retraining, the internal parameters of the model may be adjusted to align its outputs more closely with human editorial standards. As discussed, the retraining process may be conducted selectively, only when the number of failing articles exceeds the threshold. As used herein, the threshold is set to indicate when the model's outputs consistently fail to meet the quality expectations and therefore requires model refinement. The selective approach preserves computational resources by avoiding unnecessary retraining cycles.

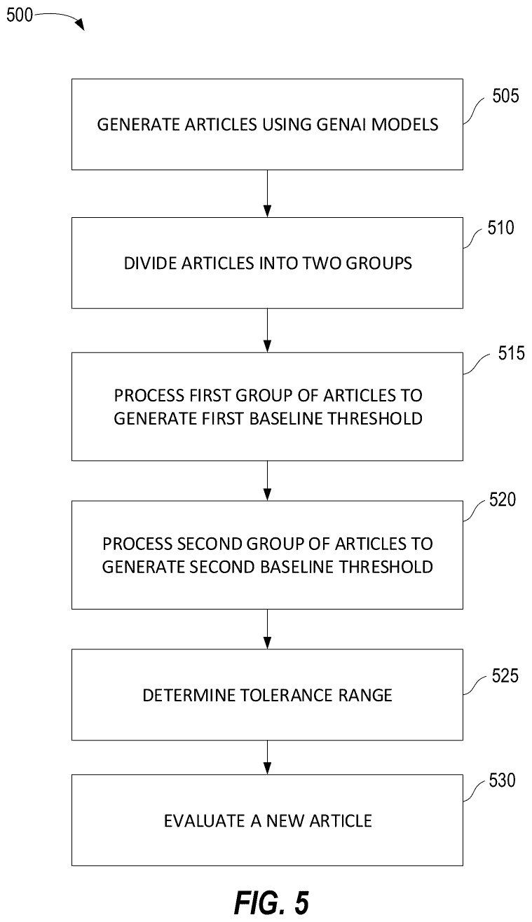

FIG. 5 depicts an example method 500 for constructing a Theory of Mind for generative AI models by formulating baseline thresholds and a tolerance range, according to some embodiments of the present disclosure. In some embodiments, the method 500 may be performed by one or more computing devices or systems, such as the computer 101 as depicted in FIG. 1.

At block 505, a computing system generates a collection of articles (e.g., 210 of FIG. 2) using a generative AI model (e.g., LLM) (e.g., 205 of FIG. 2). These articles are generated based on one or more predefined prompts, which guide the AI model in producing content that aligns with specific topics or structures.

At block 510, the computing system divides the generated articles into two groups (e.g., 210-1 and 210-2 of FIG. 2). The articles in the first group are manually reviewed and refined by human editors to align with predefined editorial standards, while the articles in the second group remain in their original and unedited AI-generated form.

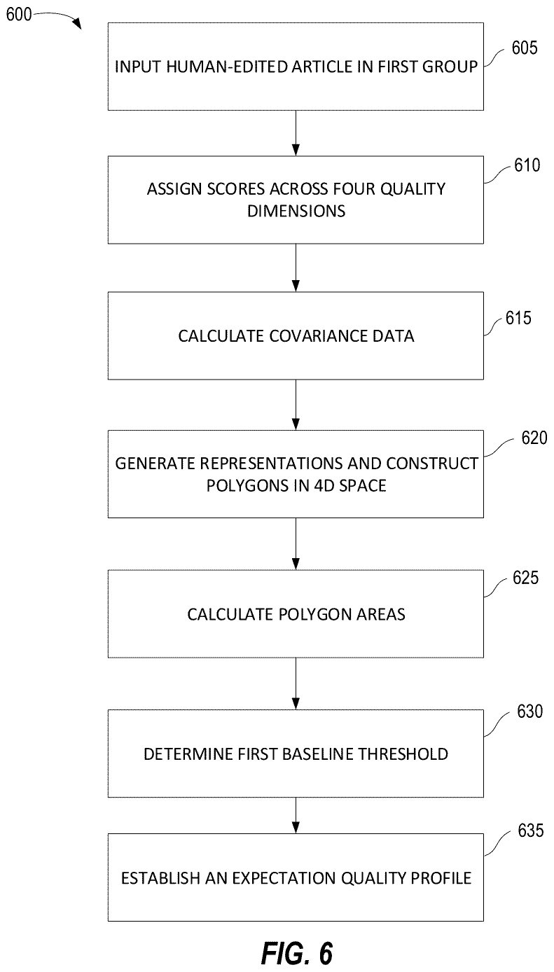

At block 515, the computing system processes the first group of articles to determine the first baseline threshold (also referred to in some embodiments as human-editing baseline threshold). This process begins with assigning scores (e.g., 215 of FIG. 2) to each article across multiple quality dimensions, such as factuality, novelty, repetitiveness, and relevancy. With the assigned scores, the system then calculates a covariance matrix (e.g., 220 of FIG. 2) to determine the interrelationships between these dimensions. Following that, the system generates an article matrix (e.g., 225 of FIG. 2) for each article, which represents the article in a multi-dimensional metric space. Based on these matrices, the system constructs polygons (e.g., 230 of FIG. 2), calculates their areas (e.g., 235 of FIG. 2), and uses the aggregated area data to determine the first baseline threshold (e.g., 240 of FIG. 2). This threshold reflects the editorial quality standards determined from human-edited articles and serves as a reference for evaluating the quality of future new articles generated by the GenAI model. Detailed steps for this process are provided below with reference to FIG. 6.

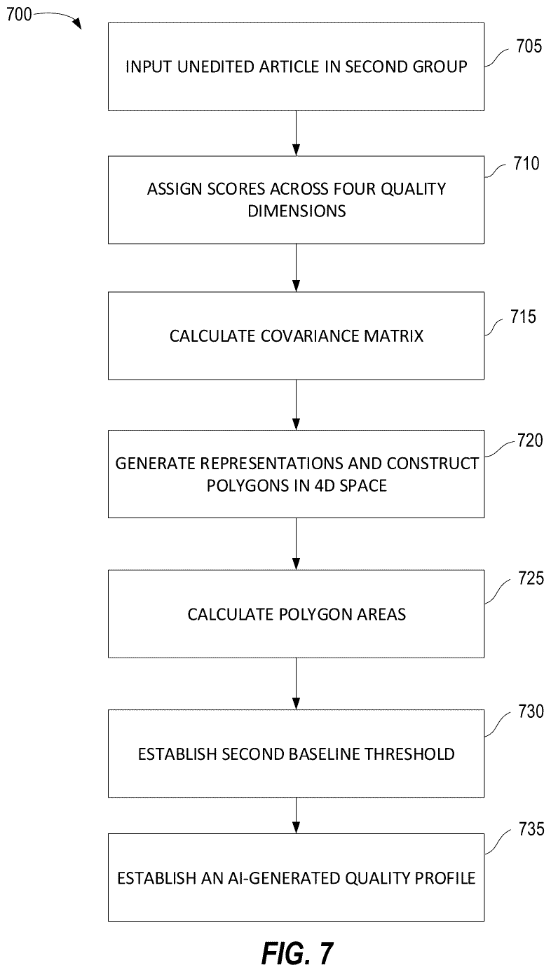

At block 520, the computing system processes the second group of unedited articles (e.g., 210-2 of FIG. 3) to calculate the second baseline threshold (also referred to in some embodiments as the AI-generated quality threshold) (e.g., 340 of FIG. 3). Similar to processing the articles in the first group, this process involves scoring the articles across multiple quality dimensions (e.g., 315 of FIG. 3), calculating covariance data (e.g., 320 of FIG. 3) to capture interrelationship between dimensions, constructing polygons (e.g., 330 of FIG. 3) in a multi-dimensional space for each unedited article, and establishing the second baseline threshold (e.g., 340 of FIG. 3) based on the average polygon area (e.g., 335 of FIG. 3) of these unedited articles. The second baseline threshold reflects the inherent quality of the raw outputs produced by the GenAI model without human intervention. Detailed steps for this process are provided below with reference to FIG. 7.

At block 525, the computing system compares the first baseline threshold (determined from human-edited articles) with the second baseline threshold (determined from unedited articles) to calculate a difference. As used herein, the difference quantifies the gap between the quality of AI-generated outputs and human editorial standards. Based on the difference, as well as other relevant factors such as stakeholder preferences and/or application requirements, the computing system determines a tolerance range (e.g., 345 of FIG. 3). As used herein, the tolerance range represents the allowable deviation from the first baseline threshold while maintaining acceptable quality standards (e.g., Baseline_{edit}±X %).

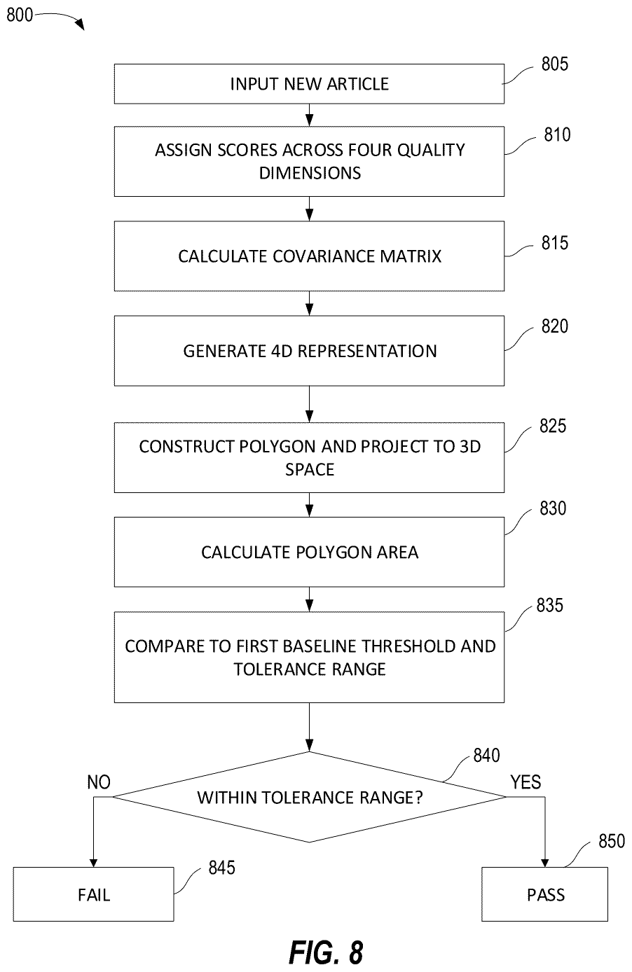

At block 530, the system evaluates a new article (e.g., 405 of FIG. 4) generated by the GenAI model (e.g., 205 of FIG. 2). The new article is scored (e.g., across 4 quality dimensions), transformed into a multi-dimensional representation (e.g., 425 of FIG. 4), and the article's quality is quantified through polygon area calculation. The area (e.g., 435 of FIG. 4) is then compared against the defined tolerance range (e.g., 345 of FIG. 4) to determine whether the new article meets the editorial standards or requires further review and/or editing. Detailed steps for this process are provided below with reference to FIG. 8.

As mentioned above, the Theory of Mind refers to the ability to predict and align with human editorial intentions and knowledge to produce coherent and publishable content. The determined parameters, such as the first baseline threshold (e.g., 240 of FIG. 2), the second baseline threshold (e.g., 340 of FIG. 3), and the tolerance range (e.g., 345 of FIG. 3), collectively form a computational representation of the Theory of Mind. When integrated into a GenAI system, these parameters enable the system to evaluate whether its outputs satisfy predefined editorial standards. If the outputs fall outside the acceptable range, the system may flag these articles for review, or even in some embodiments, retrain the GenAI model to better align its outputs with human expectations with minimal (or at least reduced) manual intervention. In some embodiments, the system may automatically update the article content to align it more closely with the editorial standards. These updates may include refining sentences to improve coherence and readability, rechecking article content to ensure accuracy, or revising stylistic elements to match the intended tone or style.

FIG. 6 depicts an example method 600 for generating a first baseline threshold, according to some embodiments of the present disclosure. In some embodiments, the method 600 may be performed by one or more computing devices or systems, such as the computer 101 as depicted in FIG. 1.

At block 605, a computing system inputs the articles from the first group (e.g., 210-1 of FIG. 2), which have been reviewed and refined by human editors to align with predefined editorial standards.

At block 610, each article is evaluated across four quality dimensions, including factuality, novelty, repetitiveness, and relevancy. Each score reflects a numerical assessment of the article's performance in a specific dimension. The score may be assigned either through human review or by machine-based scoring. In some embodiments, these scores may range from 1 to 100, with higher values indicating better performance in the respective dimensions. The example where the human-edited article is evaluated across four quality dimensions are provided for conceptual clarity. In some embodiments, the system may accommodate any number of dimensions (including one), depending on the application requirements, stakeholder preferences, and other relevant factors.

At block 615, the system calculates the covariance relationships between the quality dimensions across all articles in the first group and generates a covariance matrix (e.g., 220 of FIG. 2).

At block 620, using the assigned scores and the covariance data, the system generates a 4D representation (e.g., 225 of FIG. 2) for each article in the first group. Each article is represented by an article matrix, with diagonal elements reflecting the scores and off-diagonal elements reflecting the covariance data. Based on these matrices, the system constructs a polygon (e.g., 230 of FIG. 2) for each article in the 4D metric space.

At block 625, the polygon area for each article (e.g., 235 of FIG. 2) is calculated to quantify its overall quality. In some embodiments, a recursive dimensional reduction method (e.g., the Hausdorff dimension) may be used, including projecting the 4D polygon into 3D space, calculating triangular face areas, and aggregating these areas to determine the total polygon area. The calculated areas serves as numerical representation of the quality of each human-edited article.

At block 630, the system determines a first baseline threshold (e.g., 240 of FIG. 2) (also referred to in some embodiment as human-editing baseline threshold) using the calculated areas for the human-edited articles. The first baseline threshold reflects human editorial standards and may be used for evaluating the quality of future GenAI outputs. In some embodiments, the first baseline threshold may be determined by averaging the polygon areas (e.g., 235 of FIG. 2) of all articles in the first group. In some embodiments, a weighted average approach may be used to calculate the baseline threshold. This allows certain articles, such as those more closely aligning with the desired editorial standards, to carry greater weight in the calculation.

At block 635, the system establishes an expectation quality profile, which includes the first baseline threshold and other relevant parameters used in the evaluation (e.g., the score matrix 220 and the article matrices 225 of FIG. 2). This profile provides a structured reference for assessing future new articles.

In embodiments where the editorial standards are updated, the system may adapt by reassessing the first group of articles to maintain alignment with the new criteria. In this configuration, the articles in the first group may be reassigned scores across the updated quality dimensions, reflecting the revised editorial expectations. These updated scores are used to regenerate the score matrix (e.g., 215 of FIG. 2) for the first group. The system then recalculates the covariance data to capture any changes in the relationships between the quality dimensions under the new standards. Using the updated scores and covariance data, new article matrices (e.g., 225 of FIG. 2) are constructed, and polygons (e.g., 230 of FIG. 2) are generated in the multi-dimensional space to represent the articles based on the updated standards. The polygon areas (e.g., 235 of FIG. 2) are recalculated, and the first baseline threshold is updated by averaging the areas of the regenerated polygons. This updated baseline threshold represents the revised editorial standards and can be used for evaluating new generative AI outputs.

FIG. 7 depicts an example method 700 for generating a second baseline threshold, according to some embodiments of the present disclosure. In some embodiments, the method 700 may be performed by one or more computing devices or systems, such as the computer 101 as depicted in FIG. 1.

The method for generating the second baseline threshold is similar to the method used for generating the first baseline threshold (as depicted in FIG. 6), with the difference being that the system processes unedited articles generated directly by the AI model. These unedited articles serve as the basis for establishing the second baseline threshold (also referred to in some embodiment as the AI-generated quality threshold), which represents the inherent quality of AI-generated content without human intervention.

At block 705, a computing system inputs the unedited articles from the second group (e.g., 210-2 of FIG. 2). These articles are the raw outputs generated by the GenAI model (e.g., 205 of FIG. 2).

At block 710, the system evaluates and scores each article across four quality dimensions, including factuality, novelty, repetitiveness, and relevancy. Each score reflects a numerical assessment of the article's performance in a specific dimension. In some embodiments, the scores may range from 1 to 100. After evaluation, the system generates a score matrix (e.g., 320 of FIG. 3) for the second group articles.

The examples where the unedited article is evaluated across four quality dimensions are provided for conceptual clarity. In some embodiments, the system may accommodate any number of dimensions (including one), depending on the application requirements, stakeholder preferences, and other relevant factors.

At block 715, the system calculates the covariance relationships between the quality dimensions for the unedited articles in the second group and produces a covariance matrix (e.g., 320 of FIG. 3). The covariance matrix reflects the quality dynamics of AI-generated content.

At block 720, using the assigned scores and the covariance data, the system generates a 4D representation (e.g., 325 of FIG. 3) for each unedited article. Similar to the first group, each article in the second group is represented as an article matrix with diagonal elements capturing the scores and off-diagonal elements capturing covariance relationships. Based on these matrices, the system constructs a polygon (e.g., 330 of FIG. 3) for each article in a 4D metric space.

At block 725, the polygon area (e.g., 335 of FIG. 3) for each unedited article is calculated. As with the first group, the system uses a recursive dimensional reduction method, projecting the 4D polygon into 3D space to calculate the areas of triangular faces. These areas are then aggregated to determine the total polygon area for each unedited article.

At block 730, the system determines a second baseline threshold (also referred to in some embodiments as the AI-generated quality threshold) (e.g., 340 of FIG. 3) using the calculated areas for the unedited articles. The second baseline threshold reflects the inherent quality of AI model's outputs. In some embodiments, the second baseline threshold may be determined by averaging the polygon areas of all articles in the second group. In some embodiments, a weighted average approach may be applied, giving more weight to specific articles based on their relevance to quality standards.

At block 735, the system establishes an AI-generated quality profile, which includes the second baseline threshold and other relevant parameters generated from the unedited articles (e.g., the score matrix 320 and the article matrices 325). This profile may serve as a reference for comparison with human-edited standards and for evaluating the quality of new articles.

FIG. 8 depicts an example method 800 for processing a new article and determining the article's quality alignment, according to some embodiments of the present disclosure. In some embodiments, the method 800 may be performed by one or more computing devices or systems, such as the computer 101 as depicted in FIG. 1.

At block 805, a computing system inputs a new article generated by GenAI model. The article is the subject for evaluation, with its quality assessed against the established basslines and tolerance range.

At block 810, the system evaluates the new article across four quality dimensions, including factuality, novelty, receptiveness, and relevancy. Each score provides a numerical assessment of the article's performance within the respective quality dimension. The example of four dimension is provided for conceptual clarity. In some embodiments, the system may evaluate the article across any number of quality dimensions (including one), depending on the application requirements, stakeholder preferences, and other relevant factors.

At block 815, the system generates a 4D representation (e.g., 425 of FIG. 4) for the new article using the assigned scores and the covariance data from the human-edited articles (first group) (e.g., 220 of FIG. 2). This is to align the evaluation with the human editorial standards defined in the first baseline threshold. The new article is represented using a 4D article matrix, where diagonal elements capture the assigned scores, and off-diagonal elements incorporate covariance data to reflect interrelationship between dimensions.

At block 820, based on the 4D representation, the computing system constructs a polygon (e.g., 430 of FIG. 4) in the same space. The polygon provides a geometric representation of the article's quality profile.

At block 825, the system calculates the polygon's area (e.g., 435 of FIG. 4) to quantify the overall quality of the article. This may involve projecting the polygon into a 3D space, calculating triangular face areas, and summing these areas to determine a total polygon area.

At block 830, the calculated polygon area is compared to the tolerance range (e.g., 345 of FIG. 4), which is defined based on the first baseline threshold, the second baseline threshold, and other relevant factors (e.g., stakeholder preferences, application-specific requirements, variability in quality dimensions). If the polygon area falls within the tolerance range (e.g., Baseline_{edit}±X %), the method 800 proceeds to block 850, where the article is considered to meet the editorial standards, and the system outputs a pass decision (e.g., 445 of FIG. 4). After that, the new article may proceed directly for publication or distribution, depending on the application. If the polygon area falls outside the tolerance range, the method 800 moves to block 845, where the article is flagged as failed and requires further intervention. In some embodiments, the system may mark the article for human review or editing. In some embodiments, the system may initiate an automated process to update or adjust the content of the article. This process may involve refining sentences for coherence, rechecking factuality for accuracy, or revising stylistic elements to match intended tone and style. Additionally, in some embodiments, the number of failing articles may be recorded, and when this number exceeds a defined threshold, the system may trigger retraining of the GenAI model. For example, the difference between the first and second baselines may be used to guide the adjustments to the internal parameters of the GenAI model, making the model's outputs better align with editorial expectations.

The disclosed decision-making method 800 for new articles allows the generative AI system to align its outputs with predefined quality expectations while enabling adaptive response to failed cases.

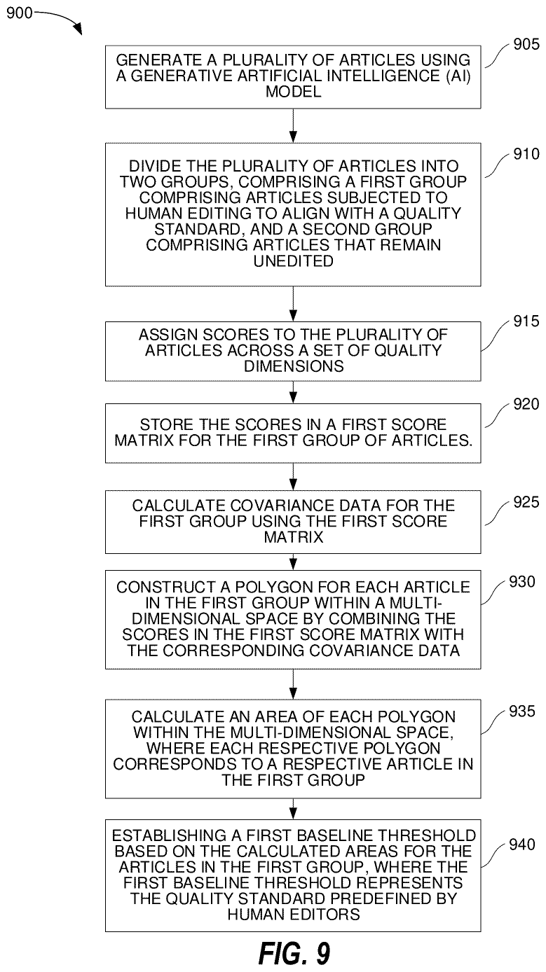

FIG. 9 is a flow diagram depicting an example method 900 for Theory-of-Mind formation for generative AI models, according to some embodiments of the present disclosure.

At block 905, a computing system generates a plurality of articles (e.g., 210 of FIG. 2) using a generative artificial intelligence (AI) model (e.g., 205 of FIG. 2).

At block 910, the computing system divides the plurality of articles into two groups, comprising a first group (e.g., 210-1 of FIG. 2) comprising articles subjected to human editing to align with a quality standard, and a second group (e.g., 210-2 of FIG. 2) comprising articles that remain unedited.

At block 915, the computing system assigns scores to the plurality of articles across a set of quality dimensions.

At block 920, the computing system stores the scores in a first score matrix (e.g., 215 of FIG. 2) for the first group of articles.

At block 925, the computing system calculates covariance data (e.g., 220 of FIG. 2) for the first group using the first score matrix.

At block 930, the computing system constructs a polygon (e.g., 230 of FIG. 2) for each article in the first group within a multi-dimensional space by combining the scores in the first score matrix with the corresponding covariance data.

At block 935, the computing system calculates an area of each polygon (e.g., 235 of FIG. 2) within the multi-dimensional space, where each respective polygon corresponds to a respective article in the first group.

At block 940, the computing system establishes a first baseline threshold (e.g., 240 of FIG. 2) based on the calculated areas for the articles in the first group, where the first baseline threshold represents the quality standard predefined by human editors.

In some embodiments, the quality dimensions may comprise at least one of factuality, novelty, repetitiveness, and relevancy.

In some embodiments, the multi-dimensional space may comprise a four-dimensional space. In some embodiments, to calculate the area of each polygon within the multi-dimensional space, the computing system may project the polygons for the articles in the first group from the four-dimensional space to a three-dimensional space, and calculate the area of each polygon within the four-dimensional space by decomposing a respective polygon into a plurality of triangular components in the three-dimensional space and summing the areas of the plurality of triangular components.

In some embodiments, the computing system may further store the scores in a second score matrix (e.g., 315 of FIG. 3) for the second group of articles, calculate covariance data (e.g., 320 of FIG. 3) for second group using the second score matrix, construct a polygon (e.g., 330 of FIG. 3) for each article in the second group within the multi-dimensional space by combining the scores in the second score matrix with the corresponding covariance data, calculate an area of each polygon (e.g., 335 of FIG. 3) within the multi-dimensional space, where each respective polygon corresponds to a respective article in the second group, and establish a second baseline threshold (e.g., 340 of FIG. 3) based on the calculated areas for the articles in the second group, where the second baseline threshold represents a quality standard established from unedited machine-generated articles.

In some embodiments, the computing system may further define a tolerance range (e.g., 345 of FIG. 3) based on the first and second baseline thresholds, where the tolerance range indicates an acceptable deviation from the first baseline threshold, construct a polygon (e.g., 430 of FIG. 4) for a newly generated article, calculate an area of the polygon (e.g., 345 of FIG. 4) corresponding to the newly generated article, and compare the area of the polygon to the tolerance range.

In some embodiments, the computing system may further approve the newly generated article in response to that the area of the polygon falls within the tolerance range.

In some embodiments, the computing system may further flag the newly generated article for review in response to that the area of the polygon falls outside the tolerance range.

In some embodiments, each vertex of the polygon (e.g., 230 of FIG. 2) represents either a score associated with a quality dimension or covariance data representing a statistical relationship between two quality dimensions.

In some embodiments, the computing system may further update the first baseline threshold (e.g., 240 of FIG. 2) based on an updated quality standard. The process may comprise assigning scores to the articles in the first group across the set of quality dimensions based on the updated quality standard, recalculating an area of each polygon (e.g., 235 of FIG. 2) within the multi-dimensional space, where each respective polygon corresponds to a respective article in the first group, and updating the first baseline threshold (e.g., 240 of FIG. 2) based on the recalculated areas to align with the updated quality standard.

While the foregoing is directed to embodiments of the present invention, other and further embodiments of the invention may be devised without departing from the basic scope thereof, and the scope thereof is determined by the claims that follow.

What is claimed is:

1. A method, comprising:
generating a plurality of articles using a generative artificial intelligence (AI) model;
dividing the plurality of articles into two groups, comprising a first group comprising articles subjected to human editing to align with a quality standard, and a second group comprising articles that remain unedited;
assigning scores to the plurality of articles across a set of quality dimensions;
storing the scores in a first score matrix for the first group of articles;
calculating covariance data for the first group using the first score matrix;
constructing a polygon for each article in the first group within a multi-dimensional space by combining the scores in the first score matrix with the corresponding covariance data;
calculating an area of each polygon within the multi-dimensional space, wherein each respective polygon corresponds to a respective article in the first group; and
establishing a first baseline threshold based on the calculated areas for the articles in the first group, wherein the first baseline threshold represents the quality standard predefined by human editors.

2. The method of claim 1, wherein the quality dimensions comprises at least one of factuality, novelty, repetitiveness, and relevancy.

3. The method of claim 1, wherein the multi-dimensional space comprises a four-dimensional space, and calculating the area of each polygon within the multi-dimensional space comprises:
projecting the polygons for the articles in the first group from the four-dimensional space to a three-dimensional space; and
calculating the area of each polygon within the four-dimensional space by decomposing a respective polygon into a plurality of triangular components in the three-dimensional space and summing the areas of the plurality of triangular components.

4. The method of claim 1, further comprising:
storing the scores in a second score matrix for the second group of articles;
calculating covariance data for second group using the second score matrix;
constructing a polygon for each article in the second group within the multi-dimensional space by combining the scores in the second score matrix with the corresponding covariance data;
calculating an area of each polygon within the multi-dimensional space, wherein each respective polygon corresponds to a respective article in the second group; and
establishing a second baseline threshold based on the calculated areas for the articles in the second group, wherein the second baseline threshold represents a quality standard established from unedited machine-generated articles.

5. The method of claim 4, further comprising:
defining a tolerance range based on the first and second baseline thresholds, wherein the tolerance range indicates an acceptable deviation from the first baseline threshold;
constructing a polygon for a newly generated article;
calculating an area of the polygon corresponding to the newly generated article; and
comparing the area of the polygon to the tolerance range.

6. The method of claim 5, further comprising approving the newly generated article in response to that the area of the polygon falls within the tolerance range.

7. The method of claim 5, further comprising flagging the newly generated article for review in response to that the area of the polygon falls outside the tolerance range.

8. The method of claim 1, wherein each vertex of the polygon represents either a score associated with a quality dimension or covariance data representing a statistical relationship between two quality dimensions.

9. The method of claim 1, further comprising updating the first baseline threshold based on an updated quality standard, comprising:
assigning scores to the articles in the first group across the set of quality dimensions based on the updated quality standard;
recalculating an area of each polygon within the multi-dimensional space, wherein each respective polygon corresponds to a respective article in the first group; and
updating the first baseline threshold based on the recalculated areas to align with the updated quality standard.

10. A system, comprising:
one or more memories collectively containing one or more programs; and
one or more processors, wherein the one or more processors are configured to, individually or collectively, perform an operation comprising:
generating a plurality of articles using a generative artificial intelligence (AI) model;
dividing the plurality of articles into two groups, comprising a first group comprising articles subjected to human editing to align with a quality standard, and a second group comprising articles that remain unedited;
assigning scores to the plurality of articles across a set of quality dimensions;
storing the scores in a first score matrix for the first group of articles;
calculating covariance data for the first group using the first score matrix;
constructing a polygon for each article in the first group within a multi-dimensional space by combining the scores in the first score matrix with the corresponding covariance data;
calculating an area of each polygon within the multi-dimensional space, wherein each respective polygon corresponds to a respective article in the first group; and
establishing a first baseline threshold based on the calculated areas for the articles in the first group, wherein the first baseline threshold represents the quality standard predefined by human editors.

11. The system of claim 10, wherein the quality dimensions comprises at least one of factuality, novelty, repetitiveness, and relevancy.

12. The system of claim 10, wherein the multi-dimensional space comprises a four-dimensional space, and calculating the area of each polygon within the multi-dimensional space comprises:
projecting the polygons for the articles in the first group from the four-dimensional space to a three-dimensional space; and
calculating the area of each polygon within the four-dimensional space by decomposing a respective polygon into a plurality of triangular components in the three-dimensional space and summing the areas of the plurality of triangular components.

13. The system of claim 10, wherein the operation further comprises:
storing the scores in a second score matrix for the second group of articles;
calculating covariance data for the second group using the second score matrix;
constructing a polygon for each article in the second group within the multi-dimensional space by combining the scores in the second score matrix with the corresponding covariance data;
calculating an area of each polygon within the multi-dimensional space, wherein each respective polygon corresponds to a respective article in the second group; and
establishing a second baseline threshold based on the calculated areas for the articles in the second group, wherein the second baseline threshold represents a quality standard established from unedited machine-generated articles.

14. The system of claim 13, wherein the operation further comprises:
defining a tolerance range based on the first and second baseline thresholds, wherein the tolerance range indicates an acceptable deviation from the first baseline threshold;
constructing a polygon for a newly generated article;
calculating an area of the polygon corresponding to the newly generated article; and
comparing the area of the polygon to the tolerance range.

15. The system of claim 14, wherein the operation further comprises approving the newly generated article in response to that the area of the polygon falls within the tolerance range.

16. The system of claim 14, wherein the operation further comprises flagging the newly generated article for review in response to that the area of the polygon falls outside the tolerance range.

17. The system of claim 10, wherein each vertex of the polygon represents either a score associated with a quality dimension or covariance data representing a statistical relationship between two quality dimensions.

18. The system of claim 10, wherein the operation further comprises updating the first baseline threshold based on an updated quality standard, comprising:
assigning scores to the articles in the first group across the set of quality dimensions based on the updated quality standard;
recalculating an area of each polygon within the multi-dimensional space, wherein each respective polygon corresponds to a respective article in the first group; and
updating the first baseline threshold based on the recalculated areas to align with the updated quality standard.

19. One or more computer-readable media containing, in any combination, computer program code that, when executed by a computer system, performs an operation comprising:
generating a plurality of articles using a generative artificial intelligence (AI) model;
dividing the plurality of articles into two groups, comprising a first group comprising articles subjected to human editing to align with a quality standard, and a second group comprising articles that remain unedited;
assigning scores to the plurality of articles across a set of quality dimensions;
storing the scores in a first score matrix for the first group of articles;
calculating covariance data for the first group using the first score matrix;
constructing a polygon for each article in the first group within a multi-dimensional space by combining the scores in the first score matrix with the corresponding covariance data;
calculating an area of each polygon within the multi-dimensional space, wherein each respective polygon corresponds to a respective article in the first group; and
establishing a first baseline threshold based on the calculated areas for the articles in the first group, wherein the first baseline threshold represents the quality standard predefined by human editors.

20. The one or more computer-readable media of claim 19, wherein the operation further comprises:
storing the scores in a second score matrix for the second group of articles;
calculating covariance data for second group using the second score matrix;
constructing a polygon for each article in the second group within the multi-dimensional space by combining the scores in the second score matrix with the corresponding covariance data;
calculating an area of each polygon within the multi-dimensional space, wherein each respective polygon corresponds to a respective article in the second group; and
establishing a second baseline threshold based on the calculated areas for the articles in the second group, wherein the second baseline threshold represents a quality standard established from unedited machine-generated articles.
